(19) United States
(12) Patent Application Publication
(10) Pub. No.: US 2022/0309413 A1
(43) Pub. Date: Sep. 29, 2022

(54) METHOD AND APPARATUS FOR AUTOMATED WORKFLOW GUIDANCE TO AN AGENT IN A CALL CENTER ENVIRONMENT

(71) Applicant: UNIPHORE SOFTWARE SYSTEMS INC.SYSTEMS I SOFTWARE SYSTEMS INC., Palo Alto, CA (US)

(72) Inventors: Samith RAMACHANDRAN, Palo Alto, CA (US); Umesh SACHDEV, Fremont, CA (US)

(21) Appl. No.: 17/211,792

(22) Filed: Mar. 24, 2021

(30) Foreign Application Priority Data
Mar. 24, 2021 (IN) 202111012643

(51) Int. Cl. G06Q 10/06; H04M 3/51; G06F 40/174; G06N 20/00

(52) U.S. Cl. CPC G06Q 10/0633; H04M 3/5133; G06F 40/174; G06N 20/00; G06F 3/0481

(57) ABSTRACT

A method and apparatus for providing an automated workflow guidance to an agent during an active call between the customer and an agent is disclosed. The method includes extracting, at a call analytics server (CAS), from a transcribed text of an audio of a call between a customer and an agent, a call context. The method further includes identifying, by the CAS, at least one workflow based on at least one of the call context, a call metadata, or a historical data, wherein the at least one workflow is identified from a plurality of workflows in a workflow repository remote to the CAS. The identified workflow is sent as guidance from the CAS to a graphical user interface (GUI) accessible by the agent, while the call is active.

### CROSS REFERENCE

This application claims priority to Indian Application No. 202111012643, filed on 24 Mar. 2021, which is incorporated herein by reference in its entirely.

### FIELD

The present invention relates generally to improving call center computing and management systems, and particularly to providing automated guidance regarding a workflow to an agent during an active call, in a call center environment.

### BACKGROUND

Several businesses need to provide support to its customers, which is provided by a customer care call center. Customers place a call to the call center, where customer service agents address and resolve customer issues, to satisfy the customer's queries, requests, issues and the like. The agent uses a computerized call management system used for managing and processing calls between the agent and the customer. The agent attempts to understand the customer's issues, provide appropriate resolution, and achieve customer satisfaction.

Different customer service agents in a call center do not have a similar knowledge, skill or even training level. During an active call, the agents need to recall workflows defining Standard Operating Procedures (SOPs) or search for the workflows to address a customer issue. Searching for this information can be cumbersome and lengthy for a new agent or an agent with less knowledge, training and/or skill, which manifests as long hold times and/or long resolution times, which may lead to negative customer experience and customer satisfaction.

Accordingly, there exists a need for improved call center computing and management systems, which can provide real-time automated guidance on a workflow to be used to an agent.

### SUMMARY

The present invention provides a method and an apparatus for providing automated workflow guidance to an agent in a call center environment during an active call, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram depicting an apparatus for providing automated workflow guidance to an agent in a call center environment, in accordance with an embodiment of the present invention.

FIG. 2 is a flow diagram of a method for providing automated workflow guidance to an agent in a call center environment, for example, as performed by the apparatus of FIG. 1, in accordance with an embodiment of the present invention.

FIG. 3 is a schematic depiction of a user interface presented to an agent of FIG. 1, in accordance with an embodiment of the present invention.

### DETAILED DESCRIPTION

Embodiments of the present invention relate to a method and an apparatus for providing automated workflow guidance to an agent in a call center environment, for example, during a voice call between an agent and a customer of a business. A workflow is a series of steps or actions that an agent is supposed to take in order to fulfil a request or address a situation pertaining to the customer. The workflow includes, for example, populating a form to intake information, sending an email, issuing a refund, and the like, that an agent needs to take in order to fulfil or address a customer request or customer's reason for the call. Workflow guidance is provided based on one or more of call context extracted from the transcribed text of the conversation, call metadata and historical data. Context is extracted from transcribed audio of the call or a portion of the call, such as a turn of a speaker (agent or customer). As the call progresses with a turn-by-turn speech of the customer and the agent, the speech is transcribed, and a portion of the transcribed speech or the entirety of the transcribed speech is used to extract context. Call metadata is obtained from systems of the business, and historical data is obtained from stored call analytics corresponding to the customer.

Call context includes call intent or reason, call topics, and call entities or portions of the transcribed text that help define what the call is about. Call entities include descriptors, such as names or identifiers, for example, the name of a customer, type of insurance, for example, car insurance, fire damage insurance, among others claim identification number, insurance company and third-party agent (TPA) details insurance claim amount, claim date, among others. Call metadata includes information related to the call, from which information such as customer profile, history of calls including previously suggested workflow, previous action adopted by the customer and results obtained therefrom and the like, are extracted. Call metadata is obtained from a call metadata source such as customer relationship management (CRM) system for the business regarding which the customer calls the agent. Historical data typically includes customer satisfaction history, call resolution history, feedback history and other speech analytics derived from previous calls of the customer.

Typically, one or more of the call context, call metadata or historical data are matched to identify at least one predefined workflows, for example, as defined by the business. Non-limiting examples of workflows include fire damage insurance claim for rental property workflow, fire damage insurance claim for owner property workflow, fire damage insurance subscription workflow, vehicle insurance subscription workflow, vehicle damage insurance claim workflow, among others. In operation, one or more of the call context, the call metadata or the historical data are matched to one or more workflow obtained from a workflow repository by an algorithm or a trained artificial intelligence (AI) and/or machine learning (ML) model (AI/ML model), which is trained to receive such inputs, match the inputs to one or more workflows, and outputs workflows that are a match with the inputs.

One or more matched workflows identified in the manner discussed above are presented to the agent as guidance, that is as a recommended workflow while the call is active, so that the agent can operate according to the recommended workflow during the call. Each workflow includes at least one step representing an action or a step or a process step. The action includes intake of information, such as populating information from the customer in a form field of a form designed to intake such information, triggering additional actions, such as issuing a refund, adding a note, adding a later action, among others. As an example, a workflow for fire damage claim for owner property may include a form as a first step, and the form includes form fields for information details such as customer ID, claim ID, claim amount, and the like.

A second step of the workflow may include a form for information details such as incident date, police report availability, details of damaged property, and the like. A third step of the workflow may include a form for information details such as cause of damage e.g. electrical fires, flammable substance leakage, and the like. In some embodiments, the form fields are automatically filled up and pre-populated using the context data. The workflow forms are presented with such pre-populated details. In some embodiments, the form fields are filled up by an input provided by the agent to the GUI. In some embodiments, the form fields are automatically filled up in real-time while the call is active, and in some embodiments, the forms are filled up after the call, for example, using one or more of the call context, call metadata or historical data. In some embodiments, the agent provides feedback regarding relevancy of the recommended workflows. The agent feedback and whether the recommended workflow was offered to the customer may be used to improve the matching and recommendation of the workflow. The feedback history from either the customer and/or the agent is included in the historical data and is used to improve the recommendation of the same or similar workflow next time for the same customer, or for other customers.

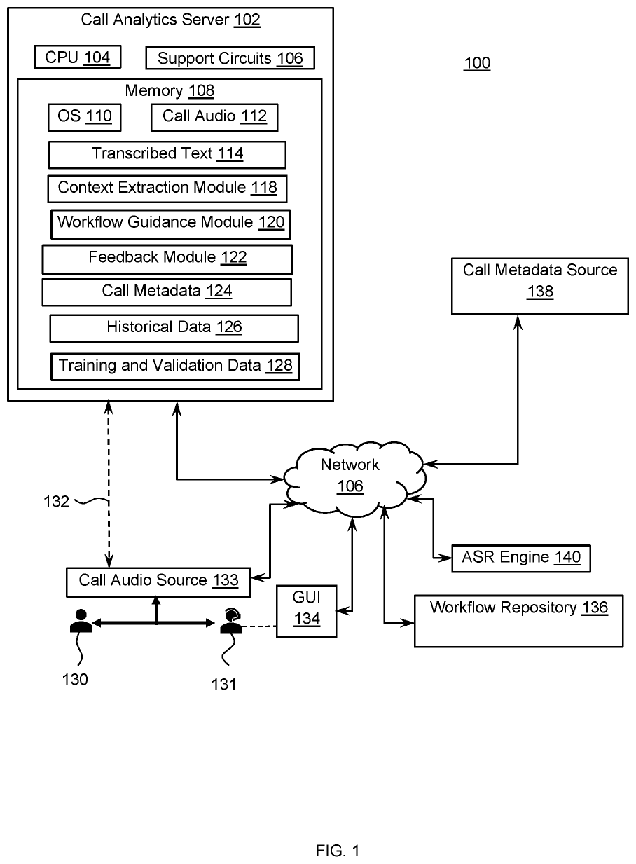

FIG. 1 is a schematic diagram of an apparatus 100 for providing workflow guidance to an agent in a call center environment, in accordance with an embodiment of the present invention. The apparatus 100 includes a call audio source 133, an automatic speech recognition (ASR) engine 140, a call metadata source (CMS) 138, a workflow repository 136, and a call analytics server (CAS) 102, each communicably coupled via a network 135. In some embodiments, the call audio source 133 is communicably coupled to the CAS 102 directly via a link 132, separate from the network 135, and may or may not be communicably coupled to the network 135.

The call audio source 133 provides audio of a call to the CAS 102. In some embodiments, the call audio source 133 is a call center providing live or recorded audio of an ongoing call between a call center agent 131 and a customer 130 of a business which the call center agent 131 serves. In some embodiments, the call center agent 131 interacts with a graphical user interface (GUI) 134 for viewing and providing inputs with respect to recommended workflow guidance. In some embodiments, the GUI 134 is a part of a computing device, and the GUI is capable of displaying an output to the agent 131, and receiving one or more inputs from the agent 131. In some embodiments, the GUI 134 is a part of the call audio source 133, and in some embodiments, the GUI 134 is communicably coupled to the CAS 102 via the network 135.

The ASR engine 140 is any of the several commercially available or otherwise well-known ASR engines, as generally known in the art, providing ASR as a service from a cloud-based server, a proprietary ASR engine, or an ASR engine which can be developed using known techniques. ASR engines are capable of transcribing speech data to corresponding text data using automatic speech recognition (ASR) techniques as generally known in the art. In some embodiments, the ASR engine 140 is implemented on the CAS 102 or is co-located with the CAS 102.

The network 135 is a communication network, such as any of the several communication networks known in the art, and for example a packet data switching network such as the Internet, a proprietary network, a wireless GSM network, among others. The network 135 is capable of communicating data to and from the call audio source 133 (if connected), the ASR engine 140, the CMS 138, the workflow repository 136, the CAS 102 and the GUI 134.

The CMS 138 includes a customer relationship management (CRM) system of the business, regarding which the customer makes the call to the business' call center agent. The CMS 138 includes information about one or more of the customer, the agent or the business, among other information relating to the call. The information obtained from the CMS 138 is referred to as call metadata.

The workflow repository 136 includes several workflows that may be recommended to a customer of the business, and in some embodiments, the workflow repository 136 is implemented by the business, or by a third party. In some embodiments, either or both of the CMS 138 and the workflow repository 136 are co-located with the CAS 102. A workflow includes one or more steps representing an action, and such actions are included in a sequence. The action may include, without limitation, populating form fields, modifying the account (adding information, issuing refund, and the like), a trouble-shooting workflow involving a multi-step/multi-branch decision steps, an information collection workflow, a retrieval and form filling workflow, a workflow involving authorization or approval from another party, a workflow triggering external automated scripts or bots for performing an action, e.g., issuing a refund, fetching a credit score, associated therewith, among several others.

The CAS 102 includes a CPU 104 communicatively coupled to support circuits 106 and a memory 108. The CPU 104 may be any commercially available processor, microprocessor, microcontroller, and the like. The support circuits 106 comprise well-known circuits that provide functionality to the CPU 104, such as, a user interface, clock circuits, network communications, cache, power supplies, I/O circuits, and the like. The memory 108 is any form of digital storage used for storing data and executable software. Such memory includes, but is not limited to, random access memory, read only memory, disk storage, optical storage, and the like. The memory 108 includes computer readable instructions corresponding to an operating system (OS) 110, a call audio 112, for example, audio of a call between a customer 130 and an agent 131 received from the call audio source 133, transcribed text 114, transcribed from the call audio 112, a context extraction module (CEM) 118, call context 116, for example, as obtained from the CEM 118, call metadata 124 as obtained from the CMS 138, a workflow guidance module (WGM) 120, training and validation data 128, a feedback module 122, and historical data 126.

The transcribed text 114 is generated by the ASR engine 140 from the call audio 112. In some embodiments, the call audio 112 is transcribed in real-time, that is, as the conversation is taking place between the customer 130 and the agent 131. In some embodiments, the call audio 112 is transcribed turn-by-turn, according to the flow of the conversation between the agent 131 and the customer 130.

The CEM 118 extracts call context 116 from the transcribed text 114. The call context includes call intent or reason, call topics or and call entities or portions of the transcribed text that help define what the call is about. Call entities include descriptors, such as names or identifiers, for example, the name of a customer, customer ID, claim identification number, insurance company and third-party agent (TPA) details, insurance claim amount, claim date, among others. Call intent includes identifying a reason for the call, for example, insurance claim for fire damage on rental property, and is based on identifying phrases and/or verbs associated with nouns, for example, claiming a fire damage insurance. In some embodiments, the CEM 118 is an artificial intelligence and/or machine learning (AI/ML) model, and in some embodiments the CEM 118 is an algorithmic module. The CEM 118 extracts call context using Natural Language Processing (NLP) techniques as known in the art on transcribed text of the call, Together, the call intent, historical data and the call entities or call topics provide a context to the call, as to the reason for the call, and the pertinent identifiers defining the call. The call context 116 is extracted from the transcribed text live, in real-time, while the call between the customer 130 and the agent 131 is active.

The workflow guidance module (WGM) 120 is an AI/ML module or an algorithmic module, which matches one or more of call context, call metadata or historical data with various workflows stored in a workflow repository, for example, the workflow repository 136, to identify at least one recommended workflow. The Workflow guidance module WGM 120 receives call metadata from the CMS 138, for example, in response to a request sent from the WGM 120 to the CMS 138, or automatically. Further, the WGM 120 accesses the historical data 126, which includes data generated by the feedback module 122. A workflow is identified by any of the known searching techniques in the art, and include, without limitation, search methods such as a simple indexed search into a repository of workflows using text/string tags, or an advanced Natural Language Processing (NLP) or AI/ML technique involving a semantic search and match of conversational text with the workflow descriptions or steps, among several others.

Based on the call context 116, call metadata 124 or historical data 126, the WGM 120 queries the workflow repository 136 to identify one or more workflows to present to the agent 131 during the active call. For example, one or more of the call context that the customer is claiming insurance for the fire damage on rental property, the call metadata that the customer is a first time claimant, has a high income, the historical data that the customer is calling a second time, for the same call context and was dissatisfied in the previous call, are used for identifying the workflow for the agent.

In some embodiments, the WGM 120 matches one or more parameters from one or more of the call context, the call metadata or the historical data, to a workflow from the repository 136, to identify the workflow as guidance or recommendation to the agent 131 to present to the customer 130. The matching may be performed by the WGM 120, for example, by querying the repository 136 based on parameters or terms extracted from the call context, the call metadata or historical data, or by a matching algorithm configured to match one or more such parameters or terms with workflows. In some embodiments, the matching algorithms include one or more trained AI/ML models. In some embodiments, the WGM 120 is configured to identify a single workflow, and in some embodiments, the WGM 120 is configured to identify more than one workflow as guidance for the agent 131.

In embodiments using AI/ML models, the WGM 120 is first trained using training and validation data 128 using training and validation techniques to train AI/ML models as well known in the art. The training and validation data 128 includes known best workflows that match with the customer's intent of a call, and/or workflows that match with the parameters extracted from the call context, call metadata and/or historical data, corresponding to one or more call scenarios or actual calls.

Once a workflow (or multiple workflows) is identified by the WGM 120, the WGM 120 presents the workflow to the agent 131 as guidance, for example, via the GUI 134. The agent 131 acts on the action guidance provided by the WGM 120, and interacts with the customer 130 accordingly.

In some embodiments, the feedback module 122 tracks whether the agent 131 presented the workflow to the customer 130, for example, using transcribed text of the speech of the agent 131 after the workflow guidance is presented to the agent 131, or by direct input by the agent indicating whether the workflow was presented or not. In some embodiments, the feedback module 122 tracks whether the agent 131 has provided feedback regarding relevancy of the recommended workflows. The feedback module 122 further tracks whether the form fields included in the workflow is filled up. The agent 131 feedback and whether the recommended workflow was offered to the customer 130 may be used to improve the matching and recommendation of the workflow. Customer feedback to the workflow presented may also be evaluated, for example, customer sentiment in response to the workflow may be recorded as either a simple workflow or a complex workflow and gets included in the historical data. The feedback history is thus included in the historical data and is being used to improve the recommendation of the same or similar workflow next time for the same customer, or for other customers. In some embodiments, the feedback module 122 also analyzes the feedback across different calls and different customers.

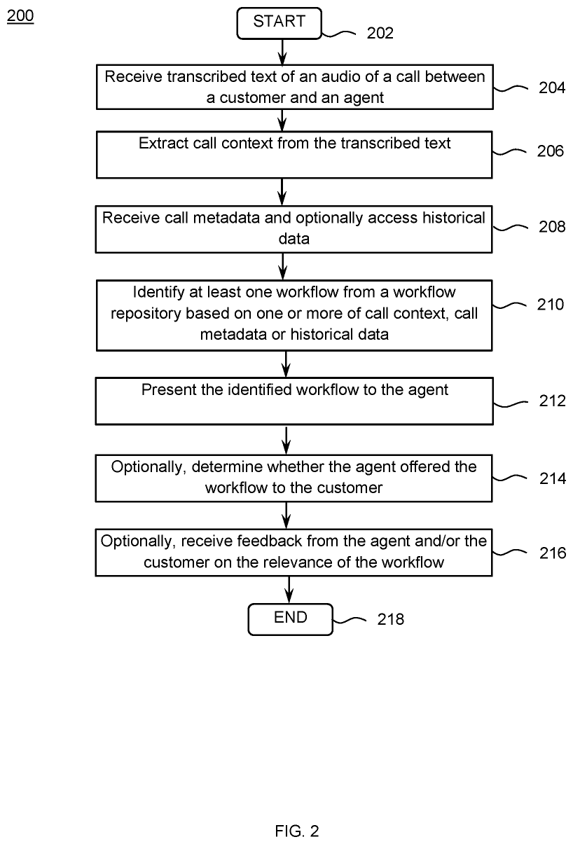

FIG. 2 is a flow diagram of a method 200 for providing workflow guidance to an agent in a call center environment, for example, as performed by the apparatus 100 of FIG. 1, in accordance with an embodiment of the present invention. In some embodiments, the method 200 is performed by various components of the CAS 102. The method 200 starts at step 202, and proceeds to step 204, at which, the method 200 receives transcribed text of an audio of a call between a customer of a business calling a call center of the business, and an agent of the call center. For example, the CAS 102 receives the transcribed text 114 from the ASR engine 140, corresponding to the conversation between the customer 130 and the agent 131. In some embodiments, the call audio 112 of the conversation is first received at the CAS 102, sent to the ASR engine 140, which transcribes the call audio 112 to generate the transcribed text 114, and sends the transcribed text 114 to the CAS 102. In some embodiments, the call audio is directly sent from the call audio source 133 (e.g., call center) to the ASR engine 140, which transcribes the call audio to the transcribed text 114. In some embodiments, the ASR engine 140 is implemented on the CAS 102 or is located locally to the CAS 102. The conversation may be transcribed according to the turn of each speaker, that is as each speaker speaks and completes their speech, or in real time, that is, as soon as possible within the constraints of communication and processing.

The method 200 proceeds to step 206, at which the method 200 extracts call context from the transcribed text 114. For example, the CEM 118 extracts the context from the transcribed text 114 by extracting an intent of the call or call intent, and an entity pertinent to the call topics or call entity, which together form the extracted context. The CEM 118 is an NLP tool as known in the art, configured to process the transcribed text 114 to extract the context. The CEM 118 is a close-ended algorithm, an AI/ML module, or a combination thereof, which using known techniques, is configured to extract call intent, and call topics or call entities from the transcribed text 114 in real-time, while the call between the customer 130 and the agent 131 is active. In some embodiments, the CEM 118 extracts the context for each turn of a speaker. That is, the CEM 118 extracts context from the transcribed text corresponding to a turn of customer speech, and then extracts context from the transcribed text corresponding to the next turn of agent speech, then of the customer speech, and so on. In some embodiments, the CEM 118 extracts context of only the customer's speech.

The method 200 proceeds to step 208, at which the method 200 receives call metadata, and optionally, accesses historical data. For example, the WGM 120 receives call metadata from the CMS 138, and accesses historical data 126, if available. The historical data 126 includes data from customer's previous calls, for example, customer satisfaction; call intent, feedback data from calls among other extracts using speech-based analytics. The historical data 126 also includes data about customer's interaction with one or more workflow, that is, customer satisfaction when presented a particular workflow.

Upon receiving call metadata and optionally access historical data at step 208, the method 200 proceeds to step 210, at which the method 200 identifies at least one workflow from a workflow repository 136 based on one or more of call context, call metadata, or historical data. According to some embodiments, the WGM 120 identifies at least one workflow from multiple workflows, in the workflow repository 136, based on the call context, the call metadata, or the historical data. In some embodiments, the WGM 120 employs an Al/ML module, for example, as generally known in the art, to match words from the call context to the workflows in the workflow repository, to identify workflow with the highest match to the call context. In some embodiments, the WGM 120 employs one or more querying, a matching algorithm, or an AI/ML module to identify workflows with the highest match to the call context.

The method 200 proceeds to step 212, at which the method 200 presents the identified workflow to the agent, for the agent to present to the customer. For example, the WGM 120 sends the identified workflows to be displayed on the GUI 134 accessible by the agent 131. Each workflow includes at least one step representing an action, the action includes populating form fields associated therewith. For example, a fire damage claim for owner property workflow may include form fields related to include a first step having action to populate information details such as customer ID, claim ID, claim amount, and the like. A second step having action to populate information details such as incident date, police report availability, details of damaged property, and the like. A third step or action to populate information details such as cause of damage, e.g., electrical fires, flammable substance leakage, and the like. In some embodiments, these form fields are automatically filled up and pre-populated using the call context. The workflow is presented with these pre-populated details. In other embodiments, the form fields are filled up by an input received at the GUI 134 by the agent 131. The identified workflows are the guidance provided automatically to the agent, and augment the agent's ability to provide relevant workflows to the customer.

The method 200 proceeds to step 214, at which the method 200 determines whether the agent 131 offered the workflow to the customer 130. For example, the agent 131 interacts with the GUI 134 to input that the agent 131 presented the workflow to the customer 130. In some embodiments, the feedback module 122 automatically determines, based on analysis of the transcribed text 114, using NLP techniques in combination with an algorithmic module and/or an AI/ML module, whether the agent 131 presented the action to the customer 130.

The method 200 proceeds to step 216, at which the method 200 optionally receives feedback from the agent and/or the customer on the relevance of the workflow. For example, the feedback module 122 presents option to provide feedback corresponding to each workflow presented, and is configured to receive an input from the agent as to whether according to the agent, the workflow was relevant for the customer, or whether the customer informed the agent as to the relevance or desirability of the workflow, or both. In some embodiments, the feedback module 122 tags the workflows according to the feedback received. For example, the feedback module 122 may tag each workflow (e.g., in the workflow repository 136) as being relevant or not relevant. Such tags form a part of the metadata for such workflows, which enables comparison of such workflows with the call context, the call metadata and/or other information including historical data, for example, for identification of a workflow according to step 208. In some embodiments, the feedback module 122 automatically determines, based on analysis of the transcribed text 114, using NLP techniques in combination with an algorithmic module and/or an AI/ML module, the feedback of the agent 131 and/or the customer 130 with respect to the presented workflow.

The method 200 proceeds to step 218, at which the method 200 ends.

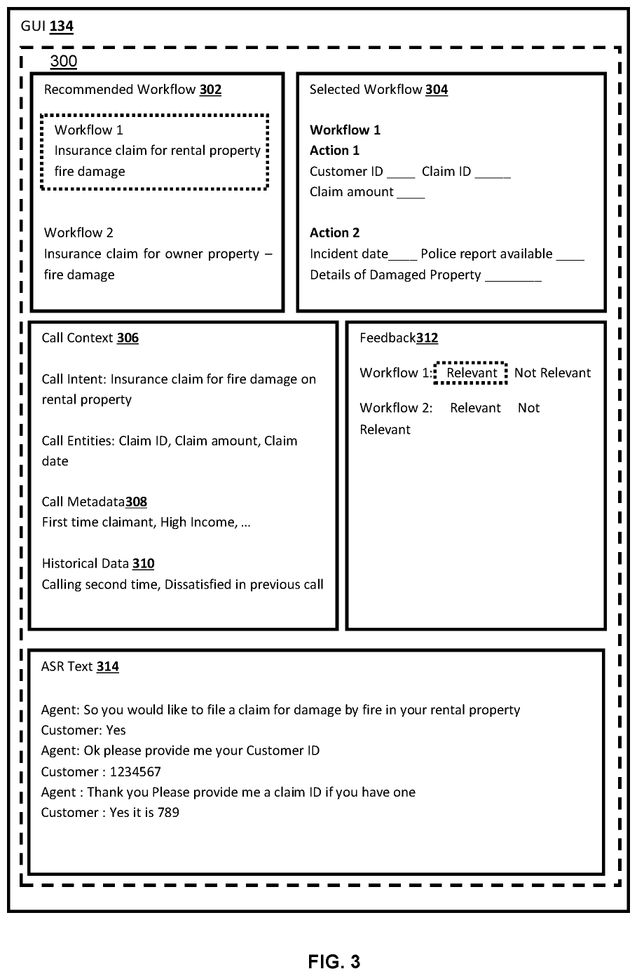

FIG. 3 is a schematic depiction of an interactive screen 300 presented on the graphical user interface 134 to the agent 131 of FIG. 1, in accordance with an embodiment of the present invention. The screen 300 includes a region 302 to display one or more recommended workflows, as presented at step 210 by the WGM 120. For example, 302 may display workflow 1 as insurance claim for rental property fire damage and workflow 2 as insurance claim for owner property fire damage. The screen 300 further includes a region 304 to display selected workflow. Each workflow having at least one step representing an action, the action includes populating form fields associated therewith. For example, a fire damage claim for owner property workflow may include a first step displayed as Action 1 having form fields related to populate information details such as customer ID, claim ID, claim amount, and the like. A second step displayed as Action 2 having form fields related to populate information details such as incident date, police report availability, details of damaged property.

The screen 300 further includes a region 312 to display feedback, for example, a relevance of each of the workflows offered marked as relevant or not relevant. The screen 300 also includes a region 306 for displaying call context. Call context includes displaying call intent for example insurance claim for fire damage on rental property, displaying call entities for example claim ID, claim amount, claim date, and the like. The screen 300 may further include call metadata display 308 for example first time claimant, high income, and the like. The screen 300 also includes historical data display 310 for example customer calling second time, dissatisfied in previous call and the like. The screen 300 further includes a region to display ASR text 314 which is the transcribed text as soon as the text becomes available, in a scrollable or automatic scrolling manner. Such text may include text from a agent for example “so you would like to file a claim for fire damage in your rental property” and customer response text for example “yes” and so on as shown in 314.

The interactive screen 300 thus provides the agent guidance as to which workflows are recommended to offer to the customer for best results, and enables feedback on the guidance received, thereby enabling iterative improvement of the entire apparatus. Based on the guidance enabled by the embodiments described herein, the agent is less likely to miss opportunities to take appropriate action, for example, present a workflow to a customer, which can help in additional business or customer retention.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/We claim:

1. A method for automatically guiding an agent during an active call between the customer and an agent, the method comprising:
extracting, at a call analytics server (CAS), from a transcribed text of an audio of a call between a customer and an agent, a call context;
identifying, at the CAS, at least one workflow based on at least one of the call context, a call metadata, or a historical data, wherein the at least one workflow is identified from a plurality of workflows in a workflow repository remote to the CAS; and
sending, from the CAS to a graphical user interface (GUI) accessible by the agent, the at least one workflow, wherein the at least one workflow is provided as guidance to the agent.

2. The method of claim 1, wherein the identifying is performed using an artificial intelligence/machine learning (AI/ML) model, wherein the AI/ML model is trained to generate an output indicating the workflow.

3. The method of claim 1, wherein extracting the call context comprises a natural language processing (NLP) of the transcribed text.

4. The method of claim 1, wherein the call context comprises at least one of a call intent, a call topic or a call entity.

5. The method of claim 1, wherein the at least one workflow comprises at least one step, the at least one step comprising populating a form field with information.

6. The method of claim 5, wherein the form field is filled up either automatically using at least one of the call context, the call metadata, the historical data, or by an input received at the GUI from the agent.

7. The method of claim 6, wherein the form field is filled up while the call is active, or after the call, or partially while the call is active and partially after the call.

8. An apparatus for automatically guiding an agent during an active call between the customer and an agent, the apparatus comprising:
at least one processor;
a memory communicably coupled to the at least one processor, the memory comprising computer executable instructions, which when executed by the at least one processor perform a method comprising:
extracting, at a call analytics server (CAS), from a transcribed text of an audio of a call between a customer and an agent, a call context,
identifying, by the CAS, at least one workflow based on at least one of the call context, a call metadata, or a historical data, wherein the at least one workflow is identified from a plurality of workflows in a workflow repository remote to the CAS, and
sending, from the CAS to a graphical user interface (GUI) accessible by the agent, the at least one workflow, wherein the at least one workflow is provided as guidance to the agent.

9. The apparatus of claim 8, wherein the identifying is performed using an artificial intelligence/machine learning (AI/ML) model, wherein the AI/ML model is trained to generate an output indicating the workflow.

10. The apparatus of claim 8, wherein extracting the call context comprises a natural language processing (NLP) of the transcribed text.

11. The apparatus of claim 8, wherein the call context comprises at least one of call intent, historical data, call topics or call entities.

12. The apparatus of claim 8, wherein the at least one workflow comprises at least one step, the at least one step comprising populating a form field with information.

13. The apparatus of claim 12, wherein the form field is filled up either automatically using at least one of the call context, the call metadata, the historical data, or by an input received at the GUI from the agent.

14. The apparatus of claim 13, wherein the form field is filled up while the call is active, or after the call, or partially while the call is active and partially after the call.

15. A non-transitory computer-readable storage medium, the computer-readable storage medium including instructions that when executed by a computer, cause the computer to:
extract, at a call analytics server (CAS), from a transcribed text of an audio of a call between a customer and an agent, a call context;
identify, at the CAS, at least one workflow based on at least one of the call context, a call metadata, or a historical data, wherein the at least one workflow is identified from a plurality of workflows in a workflow repository remote to the CAS; and
send, from the CAS to a graphical user interface (GUI) accessible by the agent, the at least one workflow, wherein the at least one workflow is provided as guidance to the agent.

16. The computer-readable storage medium of claim 15, wherein the identifying is performed use an artificial intelligence/machine learning (AI/ML) model, wherein the AI/ML model is trained to generate an output indicating the workflow.

17. The computer-readable storage medium of claim 15, wherein extracting the call context comprises a natural language process (NLP) of the transcribed text.

18. The computer-readable storage medium of claim 15, wherein the call context comprises at least one of a call intent, a call topic or a call entity.

19. The computer-readable storage medium of claim 15, wherein the at least one workflow comprises at least one step, the at least one step comprising populate a form field with information.

20. The computer-readable storage medium of claim 19, wherein the form field is filled up either automatically use at least one of the call context, the call metadata, the historical data, or by an input received at the GUI from the agent.
